(19) United States
(12) Patent Application Publication
(10) Pub. No.: US 2018/0257738 A1
(43) Pub. Date: Sep. 13, 2018

(54) A Bicycle Pedal System

(71) Applicant: Footloose Pedals Proprietary Limited, Cape Town (ZA)

(72) Inventor: Hendrik Pieter Terblanche, Stellenbosch, Cape Town (ZA)

(21) Appl. No.: 15/760,016

(22) PCT Filed: Jun. 7, 2016
(86) PCT No.: PCT/IB2016/053320

§ 371 Date: Mar. 14, 2018

(30) Foreign Application Priority Data
Sep. 16, 2015 (ZA) 2015/06847

(51) Int. Cl. B62M 3/08; A43B 5/14

(52) U.S. Cl. CPC B62M 3/086; A43B 5/14

(57) ABSTRACT

A bicycle pedal system (10) comprising a pedal (12) and a cleat (14) which is attachable to a sole (16) of a shoe (18) worn by a cyclist. The pedal comprises a pedal block (19) having three sides (20.1, 20.2 and 20.3) and a pedal spindle (22). The pedal block has a generally triangular configuration when viewed in end view. Each side of the pedal block defines a flat abutment face (24) and a pair of spaced elongate rectilinear tongue formations (26) which project outwardly from the abutment face. The cleat defines a pair of groove formations (50) configured for receiving a pair of the tongue formations therein for releasably engaging the pedal block (19).

### FIELD OF INVENTION

The invention relates to a bicycle pedal system and more specifically, to a bicycle pedal system including a mating bicycle pedal and shoe formation.

### BACKGROUND TO INVENTION

In order to efficiently apply force to a bicycle pedal over more than just a downward portion of the pedal stroke, it is necessary to provide for the attachment of the cyclist's foot to the pedal. Various methods of attaching a bicycle rider's foot to a bicycle pedal are known. One such method includes the use of toe clips and straps combined with cleated shoes. In more recent times, clipless bicycle pedals have become increasing popular with both top and intermediate level cyclists who participate in touring and racing.

Current clipless pedal designs typically provide for securely attaching the foot of a cyclist to the pedal so as to allow the cyclist to apply force to the pedal through essentially the entire circle of the pedal stroke. In order to achieve this, the foot of the cyclist is securely locked to the pedal. The applicant has found that both earlier pedal designs including toe clips and straps combined with cleated shoes and current clipless pedal designs, while providing for secure locking of the cyclist's foot to the pedal, suffer from the problem of not providing adequately for release of the cyclist's foot, particularly in circumstances where the rider is about the fall. Pedal designs having toe clips require a cyclist to bend over and release the toe clip by hand, while most clipless pedal designs require a predetermined foot movement, typically an outwards twisting action of the foot, in order to effect release of the foot from the pedal. It is thus difficult and in many instances not possible for a cyclist to release his foot from pedals having toe clips or such clipless pedals during a fall or in instances where the cyclist has lost his balance. All of the aforementioned release methods require a degree of cognitive thought on the part of the cyclist combined with a physical action in order to effect release of the foot from the pedal. During a fall there is often no time for cognitive thought nor for an intricate release action as self-preservation assumes paramount importance, blocking cognitive thought processes.

It is an object of the present invention to provide a bicycle pedal system which ameliorates the abovementioned problem encountered with existing bicycle pedal systems which do not provide adequately for quick and effective release of the cyclist's foot. While the applicant believes that the bicycle pedal system of the present invention can be used by cyclists of all levels of ability, the present invention is specifically directed at intermediate level cyclists who wish to apply a force to a bicycle pedal over a greater portion of the circle described by the pedal than just the downward portion of the pedal stroke.

### SUMMARY OF INVENTION

According to the invention there is provided a bicycle pedal system comprising:

a pedal defining an axis of rotation and including at least two pairs of elongate projecting rectilinear tongue formations, the tongue formations of each pair of tongue formations, being spaced apart and extending parallel to the axis of rotation and disposed at opposite sides thereof; and

a shoe formation of a rigid construction, forming part of a shoe, the shoe formation defining a pair of complementary groove formations in which the tongue formations are received for releasably engaging the pedal.

The pedal may include a pedal block including the tongue formations and a pedal spindle to which the pedal block is rotatably mounted, the pedal spindle defining a longitudinal axis which coincides with the axis of rotation of the pedal.

The pedal block may include three pairs of tongue formations wherein the pairs of the tongue formations are symmetrically arranged and circumferentially equi-spaced around the axis of rotation of the pedal.

The pedal block may have a generally triangular configuration when viewed in end view, the pedal block defining three sides, with each of the sides including one of the pairs of the tongue formations.

Each side of the pedal block may define an outwardly facing flat abutment face, with the tongue formations projecting outwardly from the abutment face.

Each of the tongue formations may define a pair of opposite planar engagement faces which operatively engage inner sides of a particular one of the groove formations of the shoe formation when the tongue formation is received therein.

The pedal block may have an outer end and an inner end from which the pedal spindle extends, the tongue formations having corresponding inner ends and outer ends, with a distal end region of each tongue formation being bevelled at the inner end of the tongue. More specifically, the bevelled inner end of the tongue formation may define a taper angle of between 30° and 40°. Yet more specifically, the bevelled inner end of the tongue formation may define a taper angle of about 34°.

Opposite ends of the tongue formations may be convexly curved.

The shoe formation may be in the form of a cleat which is attached, in use, to a sole of a shoe.

Each groove formation of the cleat may be defined by a continuous inner side wall, a pair of opposite concavely curved end walls and an outer side wall having a central cut-out region such that the outer side wall comprises two spaced outer side wall portions, the inner side wall and the outer side wall portions defining flat inwardly facing engagement faces for engagement with the engagement faces of a particular one of the tongue formations when it is received within the groove formation.

The invention extends to the pedal for the bicycle pedal system as described and defined hereinabove.

The invention also extends to the pedal block of the pedal for the bicycle pedal system as described and defined hereinabove.

The invention extends further to the shoe formation for the bicycle pedal system as described and defined hereinabove.

### BRIEF DESCRIPTION OF THE DRAWINGS

Further features of the invention are described hereinafter by way of a non-limiting example of the invention, with reference to and as illustrated in the accompanying diagrammatic drawings. In the drawings:

FIG. 1 shows an exploded three dimensional view of a bicycle pedal system in accordance with the invention;

FIG. 2 shows a sectional side view of the pedal system of FIG. 1 in an arrangement wherein the pedal is engaged with the shoe formation;

FIG. 3 shows a plan view of the shoe formation of the bicycle pedal system of FIG. 1, illustrating the manner in which the shoe formation is mounted to a sole of a shoe;

FIG. 4 shows a side view, showing hidden detail, of a shoe to which the shoe formation of the bicycle pedal system of FIG. 1 is mounted;

FIG. 5 shows an end view of the pedal of the bicycle pedal system of FIG. 1, as seen from an inner end of the pedal;

FIG. 6 shows a three dimensional view of the pedal of the bicycle pedal system of FIG. 1, mounted to a pedal spindle of the bicycle pedal system;

FIG. 7 shows a sectional side view of the pedal and pedal spindle of FIG. 6, sectioned along section line VII-VII of FIG. 6;

FIG. 8 shows an end view, showing hidden detail, of the pedal and pedal spindle of FIG. 6 and the shoe formation in an arrangement wherein the pedal is engaged with the shoe formation;

FIG. 9 shows a side view, showing hidden detail, of the pedal and pedal spindle of FIG. 6 and the shoe formation in an arrangement wherein the pedal is engaged with the shoe formation;

FIG. 10 shows a three dimensional view of the shoe formation of the pedal system of FIG. 1, as seen from an operative outer side thereof;

FIG. 11 shows a three dimensional view of the shoe formation of the pedal system of FIG. 1, as seen from an operative inner side thereof;

FIG. 12 shows a plan view of the shoe formation of the pedal system of FIG. 1, as seen from an operative outer side thereof; and

FIG. 13 shows a sectional side view of the shoe formation of FIG. 12, sectioned along section line XIII-XIII of FIG. 12.

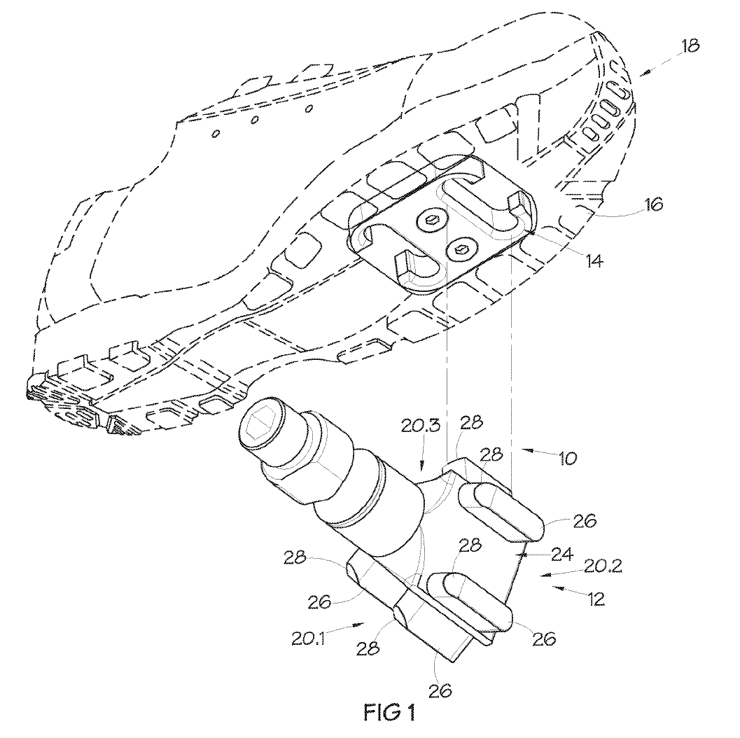

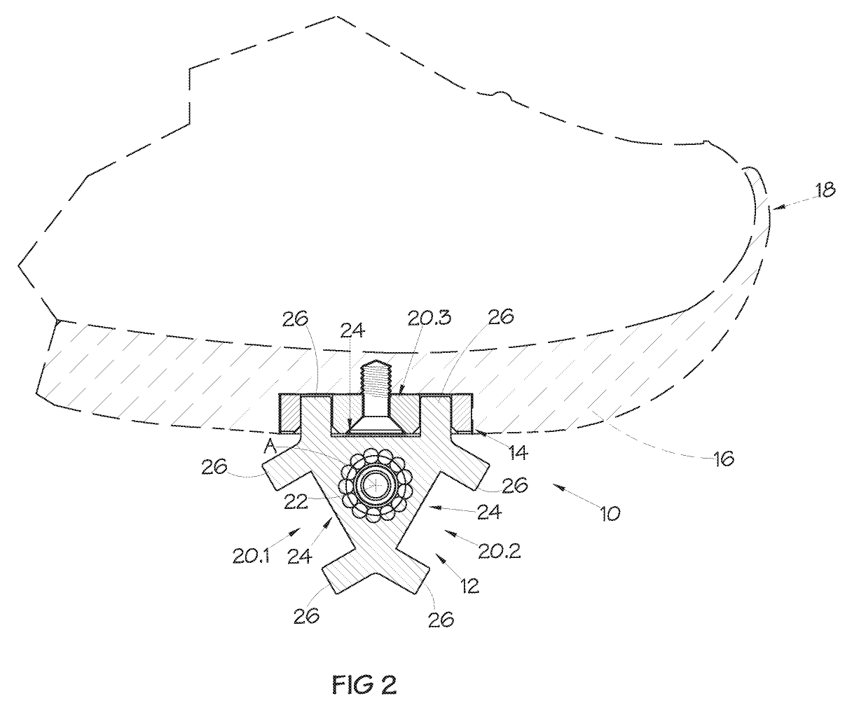

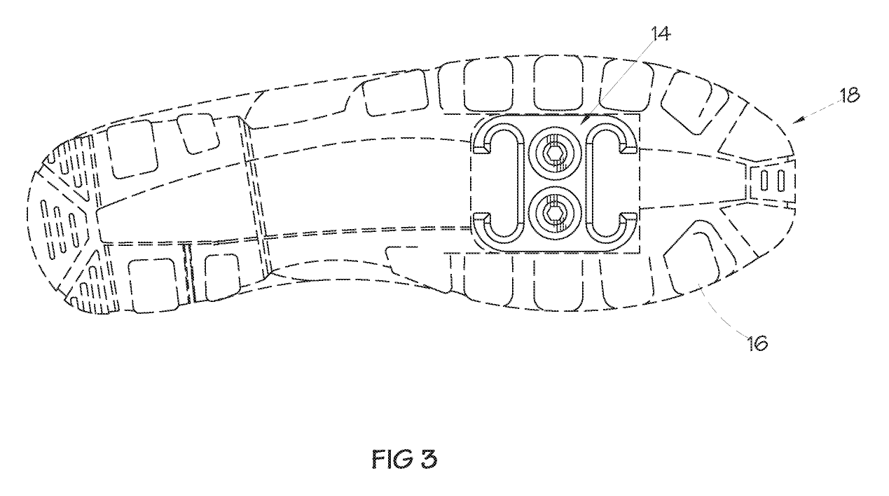

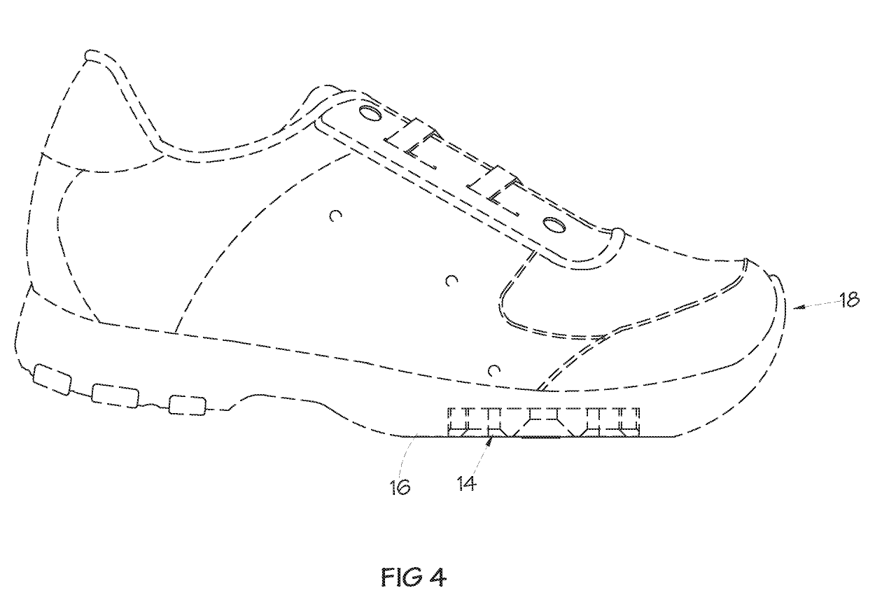

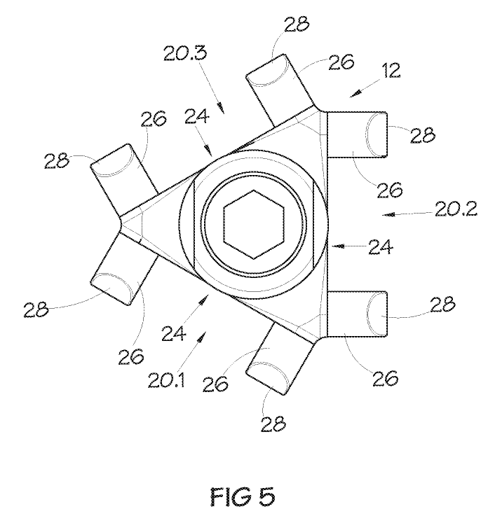

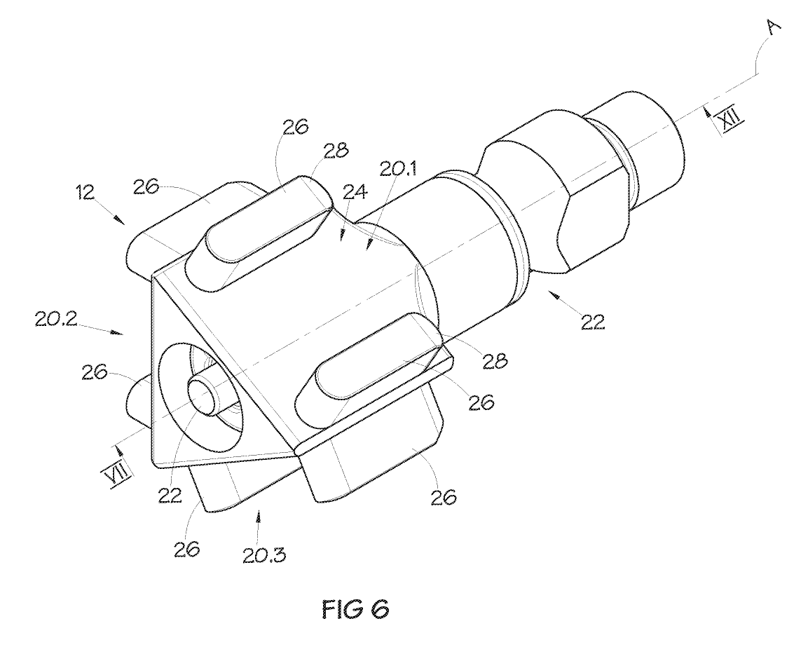

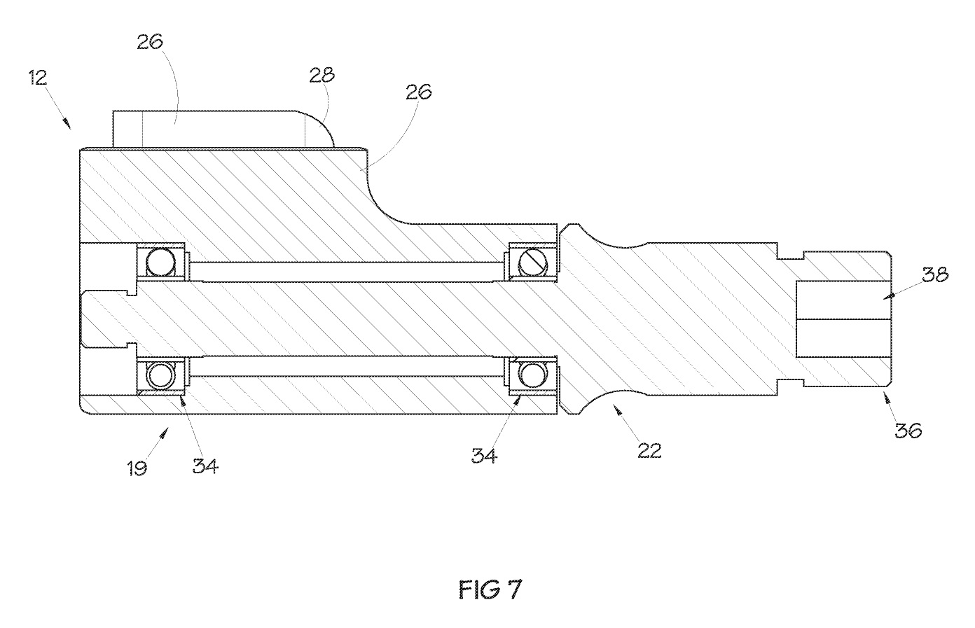

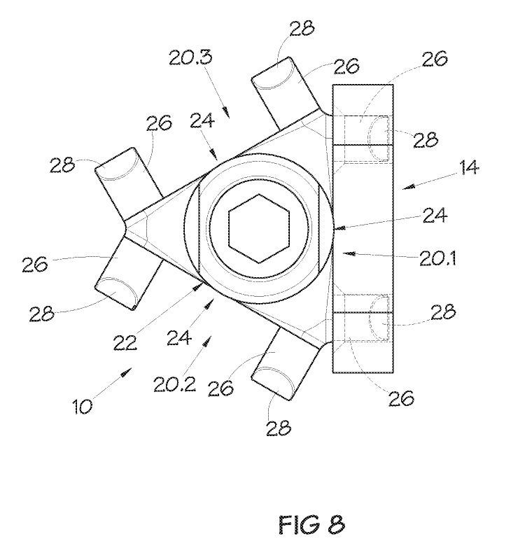

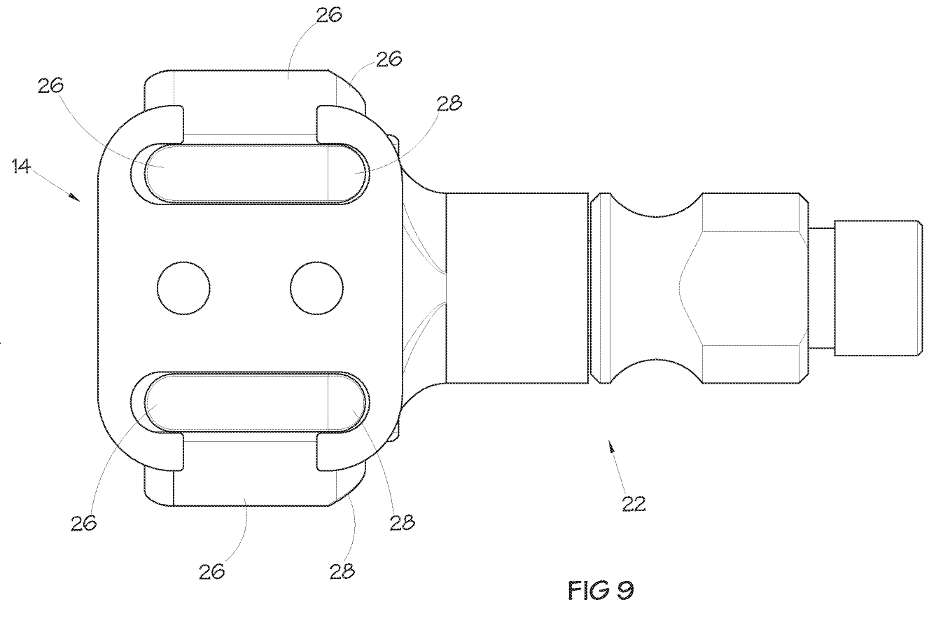

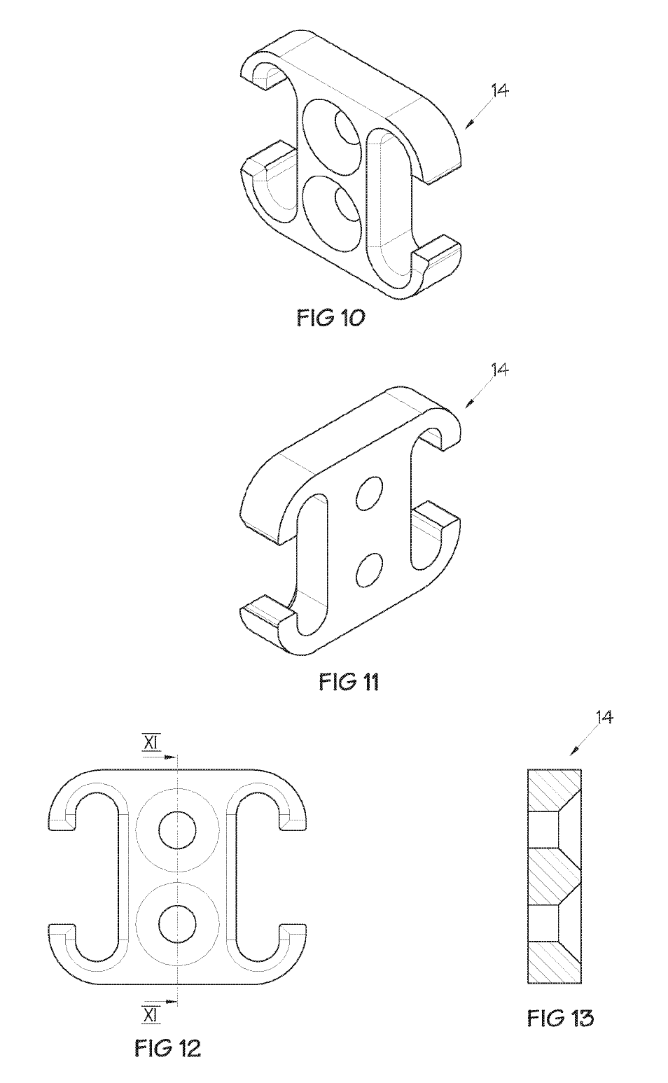

### DESCRIPTION OF PREFERRED EMBODIMENTS

With reference to the drawings, a bicycle pedal system in accordance with the invention, is designated generally by the reference numeral 10. The bicycle pedal system 10 comprises, broadly, a pedal 12 and a shoe formation in the form of a cleat 14 which is attached to a sole 16 of a shoe 18 which is worn by a cyclist.

The pedal comprises a pedal block 19 which has a generally triangular configuration when viewed in end view. The pedal block has three sides 20.1, 20.2 and 20.3 and is of a solid rigid construction. The Applicant envisages that the pedal block will be of a suitable lightweight yet rigid material such as stainless steel, titanium, aluminium or of a suitable polymer. The pedal block includes a pedal spindle 22 which is fixedly attached to a crank of a bicycle crank set.

Each side of the pedal block defines an outwardly facing flat abutment face 24 and a pair of spaced elongate projecting rectilinear tongue formations 26 which extend outwardly from each of the faces 24. More specifically, the tongue formations 26 on each side of the pedal block extend outwardly in a direction normal to the face of the relevant side.

More specifically, the pedal 12 defines an axis of rotation “A” which coincides with the longitudinal axis of the pedal spindle 22, with the tongue formations of each pair of tongue formations, being spaced apart and disposed at opposite sides and extending parallel to the axis of rotation. Each of the tongue formations defines a pair of opposite planar engagement faces 30.1 and 30.2 and have inner ends 32.1 and opposite outer ends 32.2. The inner and outer ends are convexly curved. A distal end region of each tongue formation is bevelled at the inner end 32.1 thereof so as to define a bevelled region 28. More specifically, the region 28 is bevelled so as to define a taper angle of 34°.

The pedal block 19 is rotatably mounted to the pedal spindle by means of two ball bearing assemblies 34. An end 36 of the pedal spindle defines a hexagonal socket 38 for connection to a crank of a bicycle crank set.

The cleat 14 has an inner side 46 and an outer side 48. The cleat 14 is securely attached to the sole 16 of the shoe 18 within a recessed central area 40 defined therefor within the sole. More specifically, the cleat is mounted to the sole 16 within the recess 40 by means of two screws 42 which are received within the holes 44 defined in the cleat. The holes are countersunk at the outer sides of the cleat such that the heads of the screws are recessed within the holes so as not to protrude beyond the cleat.

The cleat 14 defines a pair of groove formations 50 which are each configured and dimensioned so as to receive the tongue formations of a particular one of a pair of tongue formations therein, for releasably engaging the pedal block 19. Each groove formation 50 is defined by a continuous inner side wall 52, a pair of opposite concavely curved end walls 54 and an outer side wall having a central cut-out region such that the outer side wall comprises two spaced outer side wall portions 56.1 and 56.2. The inner and outer side walls define flat inwardly facing engagement faces for engagement with the engagement faces of a tongue formation 26 when the tongue formation is received within the groove. The groove formations and the tongue formations have complementary rounded ends so as to provide for insertion of the tongue formations into the groove formations and removal of the tongue formations therefrom.

The bevelled regions 28 of the tongue formations further facilitate ease of insertion and removal of the tongue formations into the groove formations. The Applicant has found that a taper angle of 34° for the bevelled region 28 is an optimal angle which facilitates insertion and removal of the tongue formations, yet provides for secure location of the tongue formation within the groove formation.

The Applicant believes that the bicycle pedal system in accordance with the invention, provides for attachment of a cyclist's foot to the pedal over the entire pedal stroke while allowing for quick and effective release of a cyclist's foot from the pedal simply by the cyclist lifting his or her foot from the pedal. As this requires little or no cognitive thought, the Applicant believes that the pedal system in accordance with the invention, will in most situations, permit a cyclist quickly and instinctively to separate their foot from the pedal so as to extend a leg outwardly to brace against a fall.

1. A bicycle pedal system comprising:
a pedal defining an axis of rotation and including at least two pairs of elongate projecting rectilinear tongue formations, the tongue formations of each pair of tongue formations, being spaced apart and extending parallel to the axis of rotation and disposed at opposite sides thereof; and
a shoe formation of a rigid construction, forming part of a shoe, the shoe formation defining a pair of complementary groove formations in which the tongue formations are received for releasably engaging the pedal.

2. The bicycle pedal system as claimed in claim 1, wherein the pedal includes a pedal block including the tongue formations and a pedal spindle to which the pedal block is rotatably mounted, the pedal spindle defining a longitudinal axis which coincides with the axis of rotation of the pedal.

3. The bicycle pedal system as claimed in claim 2, wherein the pedal block includes three pairs of tongue formations wherein the pairs of the tongue formations are symmetrically arranged and circumferentially equi-spaced around the axis of rotation of the pedal.

4. The bicycle pedal system as claimed in claim 2, wherein the pedal block has a generally triangular configuration when viewed in end view, the pedal block defining three sides, with each of the sides including one of the pairs of the tongue formations.

5. The bicycle pedal system as claimed in claim 4, wherein each side of the pedal block defines an outwardly facing flat abutment face, with the tongue formations projecting outwardly from the abutment face.

6. The bicycle pedal system as claimed in any one of the preceding claims, wherein each of the tongue formations defines a pair of opposite planar engagement faces which operatively engage inner sides of a particular one of the groove formations of the shoe formation when the tongue formation is received therein.

7. The bicycle pedal system as claimed in any one of claims 2 to 6, wherein the pedal block has an outer end and an inner end from which the pedal spindle extends, the tongue formations having corresponding inner ends and outer ends, with a distal end region of each tongue formation being bevelled at the inner end of the tongue.

8. The bicycle pedal system as claimed in claim 7, wherein the bevelled inner end of the tongue formation defines a taper angle of between 30° and 40°.

9. The bicycle pedal system as claimed in claim 8, wherein the bevelled inner end of the tongue formation defines a taper angle of about 34°.

10. The bicycle pedal system as claimed in any one of the preceding claims, wherein opposite ends of the tongue formations are convexly curved.

11. The bicycle pedal system as claimed in any one of the preceding claims, wherein the shoe formation is in the form of a cleat which is attached to a sole of a shoe.

12. The bicycle pedal system as claimed in claim 11, wherein each groove formation of the cleat is defined by a continuous inner side wall, a pair of opposite concavely curved end walls and an outer side wall having a central cut-out region such that the outer side wall comprises two spaced outer side wall portions, the inner side wall and the outer side wall portions defining flat inwardly facing engagement faces for engagement with the engagement faces of a particular one of the tongue formations when it is received within the groove formation.

13. The pedal for the bicycle pedal system as claimed in any one of claims 1 to 12.

14. The pedal block of the pedal for the bicycle pedal system as claimed in any one of claims 2 to 12.

15. The shoe formation for the bicycle pedal system as claimed in any one of claims 1 to 12.
